(19) United States
(12) Patent Application Publication
(10) Pub. No.: US 2022/0055283 A1
(43) Pub. Date: Feb. 24, 2022

(54) FILM INSTALLATION AND METHOD FOR PRODUCING A FILM WEB AND USE OF A ROLL APPARATUS WHICH PROCESSES FILM MATERIAL MELT

(71) Applicant: Reifenhäuser GmbH & Co. KG Maschinenfabrik, Troisdorf (DE)

(72) Inventors: Mark Schuster, Bonn (DE); Paul Walach, Troisdorf (DE); Sebastian Schippers, Troisdorf (DE)

(21) Appl. No.: 17/413,422

(22) PCT Filed: Nov. 6, 2019
(86) PCT No.: PCT/DE2019/100958

§ 371 Date: Jun. 11, 2021

(30) Foreign Application Priority Data
Dec. 11, 2018 (DE) 10 2018 131 830.8

(51) Int. Cl. B29C 55/06; B29C 43/24; B29C 43/52; B29D 7/01

(52) U.S. Cl. CPC B29C 55/06; B29D 7/01; B29C 43/52; B29C 43/24

(57) ABSTRACT

The invention relates to a film installation and a method for producing a film web, in particular a cast film installation or smoothing calender installation, having: a machine direction in which the film web is conveyed through the film installation; a roll apparatus which processes a film material melt and comprises at least one film-producing roll and a film-producing gap having temperature control apparatuses for thermally treating the film web; and a stretching apparatus for stretching the film web, wherein the stretching apparatus is situated downstream of the at least one film-producing roll in the machine direction, circumventing a critical cooling section. The invention further relates to the use of a roll apparatus which processes film material melt.

The invention relates to a film installation for producing a film web, in particular a cast film installation or smoothing calender installation, having a machine direction in which the film web is conveyed through the film installation, with a roll apparatus which processes a film material melt comprising at least one working roll, with temperature control apparatuses for thermally treating the film web and with a stretching apparatus for stretching the film web.

The invention further relates to a method for producing, in particular for casting-rolling or smooth-rolling, a film web, in which a film material melt is supplied to a relevant roll apparatus which processes a film material melt comprising at least one film-producing roll and this film material melt is formed into the film web by means of the at least one film-producing roll, and in which the film web is subsequently supplied to different temperature control apparatuses and at least one stretching apparatus.

The invention also still relates to a use of a film material melt-processing roll apparatus.

In particular, generic film installations for producing a film web are known from the prior art specifically as cast film installations or as smoothing calender installations.

The invention is based on the task of further developing generic film installations for producing a film web, but also related processes, in order to achieve improved film properties.

According to a first aspect, the task of the invention is solved by a film installation for producing a film web having a machine direction in which the film web is conveyed through the film installation, with a roll apparatus which processes a film material melt comprising at least one film-producing roll or film-producing gap, with temperature control devices for thermally treating the film web and with a stretching apparatus for stretching the film web, the film installation being characterized in that the stretching apparatus is arranged downstream of the at least one film-generating roll in the machine direction, circumventing a critical cooling section.

The fact that the stretching apparatus is arranged downstream of the at least one film-producing roll and/or correspondingly also of the film-producing gap in the machine direction, circumventing a critical cooling section, makes it possible to stretch the film web at the temperature still inherent therein with respect to the film material melt at a point in time at which the film web has not yet cooled down to below a critical stretching temperature.

In this way, the film properties can be significantly improved once again. In particular, mechanical properties in the longitudinal direction of the film can again be significantly improved.

In addition, the entire film installation, on the one hand, can be operated with particular energy efficiency for the simple reason that an energetically unfavorable cooling of the film web or the film material after removal from the film-producing roll or the film-producing gap and feeding to the apparatus is avoided or at least significantly reduced, whereby additional reheating of the film web or the film material up to or preferably to the required stretching temperature is unnecessary.

On the other hand, the present film installation is extremely compact, since additional energy-intensive heating devices can be dispensed with, because the film web does not even cool below a critical stretching temperature on a section between the roll apparatus processing the film material melt and the stretching apparatus.

First of all, it should be pointed out that, in the context of the present patent application, indefinite articles and indefinite numerical indications such as “one . . . ,” “two . . . ” etc. are generally to be understood as “at least” indications, i.e. as “at least one . . . ,” “at least two . . . ” etc., unless it is clear from the context or the specific text of a particular passage that only “exactly one . . . ,” “exactly two . . . ” etc. should be meant there.

At this point, it should also be mentioned that in the context of the present patent application the expression “in particular” is always to be understood in such a way that with this expression an optional, preferred feature is introduced. The expression is not to be understood as “and indeed” and not as “namely.”

Furthermore, the term “film installation” describes an installation by means of which a wide variety of films can be produced from a film material melt, such as a molten granulate or the like. Preferably, the film material melt is present as a plastic melt.

In particular, the invention thus relates to cast film installations or smoothing calender installations, by means of which a film material melt can be rolled into a film web and thus also into a desired film.

In this respect, with regard to the present film installation, the film material melt is preferably applied to a casting roll in the form of a melt vane by means of a suitable melt nozzle or, alternatively, is supplied into a roll gap between two smoothing rolls, so that a corresponding film web is produced from the film material melt with the aid of the casting roll or the smoothing rolls.

For the purposes of the invention, the term “film-producing roll” describes both such casting rolls and smoothing rolls. Accordingly, the “film-generating gap” described herein is regarded as a corresponding roll gap at a smoothing calender installation, the present film-generating gap then being correspondingly formed by film-generating rolls.

In this respect, features which are explained with respect to a film-producing roll also apply to a film-generating gap in connection with the present invention, even if this need not be explicitly described at corresponding points in order to avoid repetition.

Since such cast film installations or smoothing calender lines are already well known from the prior art, further functional principles will not be discussed here.

The term “film material melt-processing roll apparatus” essentially refers to the above-mentioned installations, which are characterized either by at least one casting roll or at least two smoothing rolls, which require a roll gap between them, whereby such a roll apparatus can be constructed in different ways.

For example, an extruding unit with a corresponding melt nozzle can be associated with the present roll apparatus processing film material melt, by means of which the film material melt can be provided at the respective film-producing roll.

The term “film-producing roll” in this context accordingly includes casting rolls or alternatively also smoothing rolls, also depending on which installation is used for producing the present film web.

For the purposes of the invention, the term “film web” describes a wide variety of films in the form of flat films, whereby the present invention relates to areas of application of, for example, CPP films, barrier films, hygiene films, cast PET films, protective films, films made of PS or PP, mineral-filled films or the like, in order to show here only a few possible applications by way of example.

In the sense of the present invention, the term “temperature control apparatuses” describes all installations acting thermally on the film web in addition to the roll apparatus processing the film material melt and the stretching apparatuses, which can come into direct thermal active contact or physical active contact with the film web, in particular by means of tempering rolls.

Such temperature control apparatuses can comprise apparatuses which, in particular with appropriately equipped tempering rolls, can, for example, introduce heat into the film web or also discharge heat from the film web or maintain a heat level on the film web.

In the present invention, the term “critical stretching temperature” describes a temperature on or in the film web or film material, whereby the critical stretching temperature can be in a temperature range between 70° C. and approx. 180° C., depending on which film material is used or which film web is produced.

For the purposes of the present invention, the term “critical cooling section” refers to a section between the roll apparatus processing the film material melt and the stretching apparatus, along which the film web is conveyed through the film system in the machine direction. Here, the critical cooling section is designed in such a way that the thermal energy inherent in the film web does not critically approach or drop below a critical stretching temperature limit before the film web has been conveyed to the apparatus, in particular starting from the film-producing roll.

It has been recognized in this case that the film installation can be significantly further developed in terms of its energy efficiency, if the stretching temperature required for a stretching process that can be passed through the stretching apparatus can be generated in its entirety or at least at 50%, preferably at least at 80% or more, by means of the roll apparatus processing a film material melt.

Advantageously, this avoids the film temperature dropping to below the stretching temperature after leaving the film web of the film material melt-processing roll apparatus and before reaching the stretching installation, so that the film web does not have to be heated additionally or hardly at all for a stretching process in between.

In order to avoid a critical cooling section between the roll apparatus processing the film material melt and the stretching apparatus, a transfer section or intermediate section between the roll apparatus processing the film material melt and the stretching apparatus can be designed in various ways.

For example, infrared heaters or the like can be arranged at such a transfer section in order to avoid critical cooling of the film web after removal from the film-producing roll in the sense of the invention, whereby, however, the energy balance of the present film installation would again be unfavorably influenced.

However, it is particularly advantageous, if the roll apparatus which processes the film material melt and the apparatus are arranged close to each other in such a way that the transfer distance between them is significantly shortened, so that a critical cooling distance cannot even be formed in the first place.

Thus, it is advantageous if a distance between the at least one film-producing roll or the film-producing gap, and an input roll of the apparatus is less than 1000 mm or less than 800 mm, preferably less than 500 mm or less.

Preferably, this distance or transfer distance will not be selected to be less than 200 mm or 250 mm.

In this respect, it is advantageous in this context if a distance and/or a transfer distance between the at least one film-generating roll and an input roll of the stretching apparatus is more than 200 mm or more than 250 mm, preferably more than 450 mm.

By means of such a compact construction, a critical cooling section in the sense of the invention can simply be avoided by design, whereby the energy balance of the film installation can be significantly improved compared to the prior art. In particular, the film properties can be improved thereby, as mentioned above.

In other words, the stretching apparatus is arranged so close to the film material melt-processing roll apparatus that the produced film web is preferably stretched directly with the heat still inherent in it from the casting process or smoothing process, i.e. from the first heat of the film web, so to speak.

In other words, this means that the stretching temperature of the film for stretching at the stretching apparatus ideally comes entirely from the heat of the casting-rolling process or the smooth-rolling process, as a result of which the present film installation can be operated extremely energy-efficiently. Even if only 10% of the stretching temperature originates from the heat of the casting-rolling process or the smooth-rolling process, the film installation can be operated more efficiently in the sense of the invention than in the prior art.

A significant energetic improvement can already be achieved if more than 80% of the required stretching temperature is generated by the roll apparatus processing the film material melt, i.e. comes from the heat of the casting-rolling process or the smooth-rolling process.

In this respect, it is advantageous if the film installation is characterized by a transfer distance between the at least one film-generating roll or the film-generating gap, and an input roll of the stretching apparatus, wherein the transfer distance is less than 1000 mm or 800 mm, preferably less than 500 mm or less, but preferably more than 250 mm.

While the distance between the roll apparatus processing the film material melt and the stretching apparatus preferably describes the actual distance between the two aforementioned components of the film installation, i.e. the linear distance, the transfer distance can also run in a straight line, but in contrast thereto also in a curved line between the roll apparatus processing the film material melt and the stretching apparatus.

The distance or the transfer distance can be selected depending on the type of the roll apparatus processing the used film material melt, the film material or plastic material, the thickness of the film web or the like, and the resulting cooling rate on the film web.

For example, a distance or transfer distance of 1000 mm can be selected for thicker film webs, while a smaller distance or transfer distance, such as 500 mm or less, appears necessary for thinner film webs or for film materials that require a higher stretching temperature.

One preferred embodiment variant provides, for example, that the stretching apparatus is arranged downstream of the film-producing roll in the machine direction in such a way that the film web leaving the film-producing roll can be transferred directly to the stretching apparatus. By placing the stretching apparatus directly behind the roll apparatus processing the film melt, it can be ensured that the film web passes directly to the stretching apparatus with as little heat loss as possible from the roll apparatus processing the film material melt, in particular from the film-producing roll and thus possibly also from the film-producing gap, so that additional heating or reheating of the film web prior to the actual stretching process can be omitted.

For the purposes of the present invention, the term “directly” describes the fact that the stretching apparatus is placed or arranged downstream of the roll apparatus processing a film material melt, without the interposition of any further technical device, such as an additional temperature control apparatus, such as a temperature control roll, or another roll, be it a deflection roll, a guide roll, a drive roll or the like.

Depending on the structure and area of application of the respective film installation or depending on the film to be produced, it is advantageous if the stretching apparatus comprises a film web removal roll by means of which the film web can be removed from the film-producing roll. This ensures that the film web can be removed directly from the film-producing roll by a component of the stretching apparatus, whereby a distance or transfer distance between the film-producing roll and the stretching apparatus can be significantly reduced. With this embodiment variant, critical cooling of the film web can be almost completely ruled out due to a substantially hardly existing distance or a substantially hardly existing transfer distance.

If such a direct film transfer between the roll apparatus processing the film material melt and the stretching apparatus is not possible or appears not to be sensible, for example due to increased quality requirements for the film web to be produced, it is alternatively advantageous if the stretching apparatus is arranged downstream of the film-producing roll in the machine direction in such a way that the film web leaving the film-producing roll can be transferred first to a pre-temperature control apparatus and then to the stretching apparatus. By means of such a pre-temperature control apparatus, a more uniform temperature control of the film web or a more uniform temperature distribution on the film web can be achieved, whereby the quality of a stretching process and thus the overall quality of the film web can be very well improved.

In this respect, such a pre-temperature control apparatus is preferably provided for equalizing a temperature within or on the film web, respectively, between the stretching apparatus or an input roll of the stretching apparatus and the roll apparatus processing the film material melt or its at least one film-producing roll and/or film-producing gap, respectively.

In this context, it is advantageous if the pre-temperature control apparatus comprises at least one film pre-temperature control roll, by means of which the film web can be pre-tempered at a temperature above 70° C., preferably between 90° C. and 120° C. By means of the temperatures proposed here, the film web can be tempered in such a way that the temperature of the film web is within a required stretching temperature.

If such a pre-temperature control device is provided, it is possible, for example, for the stretching apparatus to operate without temperature-controllable rolls.

Cumulatively or alternatively, it is furthermore advantageous, if the stretching apparatus comprises at least one temperature-controllable stretching roll.

On the one hand, this allows the required stretching temperature on the film web to be set even more optimally.

On the other hand, the film web can be heated directly by the stretching apparatus or the temperature already inherent in the film web can be kept simple in terms of design, even if an additional pre-temperature control apparatus is not required, for example for reasons of space.

It is particularly advantageous if the stretching apparatus allows the film web to be stretched between 0.5% and 5%, or more than 5%, at least in the machine direction, preferably by 50% or more, often also up to 1000%.

It is understood that the present stretching apparatus can be designed in a wide variety of ways in order to stretch the film web in the sense of the present invention in a desired or suitable manner in the machine direction and/or transverse to the machine direction, as a stretching process is often also called.

If the stretching apparatus comprises, for example, a flatness package, the film web can easily be stretched between 0.5% and 5%.

If the stretching apparatus cumulatively or alternatively comprises an MDO device, the film web can also be stretched more than 5% without any problems.

“MDO” stands for “Machine Direction Orientation,” i.e. the orientation of plastic molecules in the machine direction, i.e. the direction in which the film material or the film web is transported through the film installation.

Since such flatness packages or “MDO” devices are already well known from the prior art, their further construction or mode of operation will not be discussed further here.

According to a second aspect, the task of the invention is further solved by a method for producing, in particular for casting-rolling or smooth-rolling, a film web, in which a film material melt is supplied to a relevant roll apparatus which processes a film material melt having at least one film-producing roll and/or a film-producing gap, and this film material melt is formed into the film web by means of the at least one film-producing roll and/or the film-producing gap, and in which the film web is subsequently supplied to different temperature-control apparatuses and to at least one stretching apparatus, the method being characterized in that the stretching temperature required for a stretching process which can be carried out at the stretching apparatus is generated entirely or at least by 50%, preferably at least by 80% or more, by means of the roll apparatus processing a film material melt.

If the stretching temperature required at the stretching apparatus originates exclusively or at least in part from the heat of the roll apparatus processing the film material melt, additional heating of the film web upstream of the stretching apparatus can be omitted or at least greatly reduced, whereby the present film installation can be operated more efficiently.

Nowadays, flat films in particular are mainly produced by the casting or smoothing process.

Films manufactured in this way have mechanical properties, which are essentially influenced by the processing of the raw materials used and by the raw materials.

Improved mechanical properties or better optical properties can be achieved by stretching the films or film webs.

Up to now, this stretching has mainly been done inline by reheating an already cooled film web and then stretching it in a one- or two-stage stretching process. This is followed by so-called annealing and cooling.

However, the disadvantage of this prior art is that stretching takes place only after repeated reheating of an already cooled film web. Therefore, such previously known processes are energetically nonsensical or ineffective.

In addition, the film web already has a significantly higher crystalline content once it has cooled, as a result of which it is more difficult, or in some cases impossible, to orient plastic molecules of the film material differently within the film web. In particular, mechanical properties in the longitudinal direction of the film can again be significantly improved.

Advantageously, in the processes proposed here, in any case, no unnecessary heat energy is extracted from the film web, nor is any additional heat energy added, so that as a result the production of films or film webs can be carried out much more effectively.

According to a third aspect, the task of the invention is also solved by a method for producing, in particular for casting-rolling or smooth-rolling, a film web, in which a film material melt is supplied to a relevant roll apparatus which processes a film material melt having at least one film-producing roll and/or a film-producing gap, and this film material melt is formed into the film web by means of the at least one film-producing roll and/or the film-producing gap, and in which the film web is subsequently supplied to different temperature-control apparatuses and at least one stretching apparatus, the method being characterized in that the film web is stretched exclusively with the aid of the heat from the film material melt.

Advantageously, the film web is stretched by means of the aforementioned process control from the first heat, i.e. essentially the heat of the film material melt, at the stretching apparatus, so that this process control can also be carried out particularly efficiently. Here, further heat sources, such as a heatable film-producing roll, a heatable stretching roll or the like, are preferably dispensed with. In particular, mechanical properties in the longitudinal direction of the film can be significantly improved again.

Optionally, it is advantageous if the film web is additionally stretched in addition to the heat from the film material melt by means of heat from the film material melt-processing roll apparatus and the stretching apparatus. In this way, the film web can be additionally thermally treated with a very low additional energy input, namely before and/or during the stretching.

According to a fourth aspect, the task of the invention is also solved by a method for producing, in particular for casting-rolling or smooth-rolling, a film web, in which a film material melt is supplied to a relevant roll apparatus which processes a film material melt having at least one film-producing roll and/or a film-producing gap, and this film material melt is formed into the film web by means of the at least one film-producing roll and/or the film-producing gap, and in which the film web is subsequently supplied to different temperature-control apparatuses and to at least one stretching apparatus, this method being characterized in that, after leaving the at least one film-generating roll and/or the film-generating gap, the film web is stretched by a stretching apparatus, circumventing further temperature-control apparatuses.

Advantageously, the heat from the film material melt can be used directly for the subsequent stretching process, whereby further temperature-control apparatus upstream of the stretching apparatus can be dispensed with. This means that the film installation can be made particularly compact for carrying out the process. In particular, mechanical properties in the longitudinal direction of the film can again be significantly improved.

In this respect, it is advantageous if the film web is first stretched after leaving the at least one film-producing roll and/or the film-producing gap, and is therefore only subsequently supplied to further temperature-control apparatuses for thermal treatment of the film web.

In other words, this means that the film web is stretched by circumventing a critical intermediate cooling due to a critical cooling distance.

For example, it is advantageous for this purpose if the stretching apparatus is arranged between the at least one film-generating roll and/or the film-generating gap, and one of the temperature-control apparatuses, the stretching apparatus immediately comprising a film web removal roll which is connected directly downstream of the film-generating roll.

In this respect, it is advantageous if the stretching apparatus is arranged in the machine direction between the at least one film-producing roll and/or the film-producing gap, and a temperature-control apparatus and/or a cooling device of the film installation.

In the sense of the invention, the term “temperature-control apparatus” describes a heating device which serves to remove residual stress in the film web and is carried out, for example, under tensile stress (lead).

Preferably, this involves tempering to just below the actual melting temperature of the film web or film material.

It is also advantageous if the lead can be adjusted on the temperature-control device.

In the sense of the invention, the term “cooling device” describes a device by means of which the film web can preferably be cooled to almost ambient temperature.

This makes it possible to freeze plastic molecule orientations in the film web or film material.

This cooling device can comprise cooling rolls by means of which a lead can be adjusted.

The term “lead” describes a process in which one roll and/or one pair of rolls can be operated at a different speed from another roll or another pair of rolls for a short time or permanently, resulting in stretching of the film material on the film web.

According to a fifth aspect of the invention, the present task is also solved by a method for producing, in particular for casting-rolling or smooth-rolling, a film web, in which a film material melt is supplied to a film material melt-processing roll apparatus having at least one film-producing roll and/or a film-producing gap, and this film material melt is formed into the film web by means of at least one film-producing roll and/or the film-producing gap, and in which the film web is subsequently supplied to different temperature-control apparatuses and to at least one stretching apparatus, the method being characterized in that, after leaving the at least one film-generating roll and/or the film-generating gap, the film web is supplied to a pre-temperature control apparatus and is subsequently transferred from the pre-temperature control apparatus directly to a stretching apparatus, by means of which the film web is stretched.

Advantageously, the pre-temperature control apparatus can be used to equalize any different temperature ranges that may be present in the film web, so that ideally there are no (or only negligible) such different temperature ranges with different temperature levels on the film web.

In all the proposed methods, the focus is also on energy efficiency in particular, since it is avoided that the film web cools down too much in the machine direction downstream of the film material melt-processing roll apparatus, as has been the case in the prior art.

Rather, the film material web is stretched essentially immediately with the heat energy still inherent in it from the film material melt, whereby additional heating processes are preferably completely avoidable.

In this respect, it is advantageous if the film web is always kept above a critical stretching temperature, in particular at least above a temperature of 50° C. or, even better, 80° C., after removal from the film-producing roll.

This makes it possible to carry out a very high-quality stretching process solely on the basis of the inherent warmth of the film web from the film material melt. In particular, mechanical properties in the longitudinal direction of the film can be significantly improved once again.

It is advantageous to bring the film web to the desired stretching temperature by means of the pre-temperature control apparatus, if this should still be necessary, the pre-temperature control often being between 90° C. and 110° C.

It is understood that the present pre-temperature control apparatus can be designed in a wide variety of ways. For example, the pre-temperature control apparatus comprises at least one pre-temperature control roll, preferably two pre-temperature control rolls.

Ideally, both pre-temperature control rolls can be driven individually, so that the pre-temperature control apparatus can also be operated with an adjustable lead.

The film material can be directly subcooled to below its recrystallization temperature or, alternatively, the film web temperature can be kept above this recrystallization temperature.

Cumulatively or alternatively, it is advantageous if the film web is tempered after leaving the at least one film-producing roll by means of at least one stretching roll of the stretching apparatus.

Additional temperature control can thus be carried out directly by means of the stretching apparatus, although it is also conceivable that the function of the pre-temperature control apparatus can be at least partially taken over by means of the at least one stretching roll, preferably by means of several temperature control stretching rolls, of the stretching apparatus.

In any case, it is advantageous if the stretching apparatus is arranged in the machine direction directly downstream of a preheating device of the temperature control apparatuses and directly upstream of a further temperature control apparatus.

In this case, a special embodiment variant can provide that the stretching apparatus is arranged directly in the machine direction immediately downstream of the preheating device of the temperature control apparatus and upstream of further temperature control apparatuses, the further temperature control apparatuses comprising a temperature control apparatus and a cooling device, and the stretching apparatus being arranged immediately upstream of the temperature control apparatus in the machine direction.

In addition, it is particularly advantageous if the roll apparatus processing the film material melt comprises at least one casting roll or at least two smoothing rolls forming a roll gap with one another.

Furthermore, it is advantageous if the film web is tempered at least once after leaving the casting roll, namely heated, stretched immediately thereafter and then tempered differently at least once more, preferably more than once.

According to a further aspect of the invention, the task is also solved by a method for producing, in particular for casting-rolling or smooth-rolling, a film web, in which a film material melt is supplied to a relevant roll apparatus which processes a film material melt having at least one film-producing roll, and this film material melt is formed into the film web by means of the at least one film-producing roll, and in which the film web is subsequently supplied to different temperature control apparatuses and to at least one stretching apparatus, the film web being stretched after leaving the at least one film-producing roll before the film web is supplied to a temperature control apparatus of the temperature control apparatuses and/or to a cooling device of the temperature control apparatuses.

In this process, after leaving the at least one film-producing roll, the film web is selectively stretched by means of the stretching apparatus, and only then is the film web supplied to the annealing unit for removing residual stresses in the film web or to the cooling device for cooling the film.

In this respect, the film web passes from a casting roll or from smoothing rolls to the stretching apparatus before the film web is supplied to the cooling unit.

The cooling unit can comprise at least four cooling rolls.

In the sense of the invention, the stretching of the film web takes place at a significantly earlier stage than in previously known inline stretching units.

In this respect, the present processes can be operated in a more energy-efficient manner.

Here, stretching values can be realized, which generally lie between 100% and 800%.

However, it is also possible to set a so-called bow operation at the stretching apparatus, in which the film web is stretched by only 1% to 5% in order to remove flatness defects from the film, as already indicated at the beginning.

According to the invention, stretching takes place essentially by utilizing the “first heat.”

In other words, this means that the film web is stretched immediately after the actual film web production on the casting roll or between the smoothing rolls.

For a temperature comparison measurement on the film web, two additional heating rolls (pre-temperature control rolls), for example, can be connected downstream of the roll apparatus processing the film material melt. This is immediately followed by the actual stretching apparatus, which can be of single- or two-stage design. This is followed, for example, by annealing rolls of the annealing device and cooling rolls of the cooling device.

According to a sixth aspect of the invention, the task is performed by using a roll apparatus processing a film material melt for heating a film web to stretching temperature for a stretching process directly following the roll apparatus processing the film material melt at a film web producing film installation.

It is true that the film web inevitably passes through a supposedly required stretching temperature range during its production by the roll apparatus processing a film material melt. However, after leaving the roll apparatus processing the film material melt, the film web usually cools down to ambient temperature, or at least well below a designated stretching temperature. In this respect, the roll apparatus processing the film material melt has not yet been used to heat the film web for a subsequent stretching process.

However, this allows a film installation in the sense of the invention to be operated much more effectively in terms of energy.

So far, such a roll apparatus processing film material melt has been used under the aspect of cooling the film material melt during the forming of a film web. However, it has been advantageously recognized that, with an appropriate design of a film installation, this roll apparatus processing film material melt is additionally suitable, but also directly suitable as a thermal preliminary stage for a stretching apparatus of the film installation, in order to provide a stretching temperature on the film web which is required for the stretching apparatus.

It is understood that features of the solutions described above or in the claims can also be combined, if necessary, in order to be able to implement the advantages and effects achievable in the present case in a correspondingly cumulative manner.

In addition, further features, effects and advantages of the present invention are explained on the basis of the accompanying drawing and the following description, in which a film installation is shown and described by way of example.

In the drawing,

the single FIGURE schematically shows a model view of a film installation for producing a film web with a stretching apparatus arranged downstream of a roll apparatus melt-processing a film material while circumventing a critical cooling section in the machine direction.

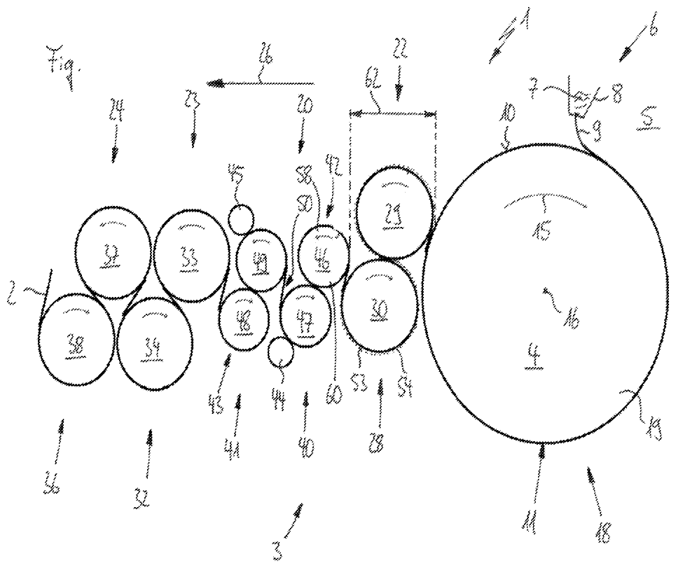

The film installation 1 shown in FIG. 1 is used for the production of films 2, which is designed here as an example as a flat film (not numbered separately).

Such film installations 1 can be designed in a wide variety of ways, for example as a cast film installation 3, as shown schematically according to the representation in the single FIGURE, as a smoothing installation (not shown) or the like.

The cast film installation 3 shown differs in the sense of the invention from a smoothing calender installation not shown, for example, essentially by a casting roll 4, which is placed on the input side or at the input 5 of the film installation 1, in contrast to smooth rolls (not shown) of a smoothing calender installation which form a roll gap (not shown).

In any case, the film installation 1 shown in the single FIGURE is a cast film installation 3 with a casting roll 4, which is connected downstream of an extruder device 6 for producing a film material melt 7, the extruder device 6 being shown by way of example only with regard to a wide spray nozzle 8, by means of which the film material melt 7 is applied to the roll surface 10 of the casting roll 4 in the form of a film material melt vane 9.

By means of the casting roll 4, the film material melt vane 9 is formed into a film web 11.

The casting roll 4 is a chromium-plated steel roll (not specified again) with a diameter of 1000 mm, which can be heated to at least 120° C. on the roll surface 10 at a temperature difference of +1-1° C. The casting roll 4 rotates about its casting roll axis 16 in a direction of rotation 15. The film web 11 can be guided around the casting roll 4 at an angle of wrap of at least 220°.

With the aid of the casting roll 4, the film material melt 7 is cooled to below a recrystallization temperature of the film material melt 7 or is kept in a range of this recrystallization temperature of the film material melt 7, the recrystallization temperature being dependent on the respective plastic film material to be processed.

In any case, the film installation 1 with the casting roll 4 already described above comprises a roll apparatus 18 which processes a film material melt 7 with at least one film-producing roll 19, namely the casting roll 4 in this embodiment.

Furthermore, the film installation 1 also comprises both a stretching apparatus 20 and temperature-control apparatuses 22, 23 and 24 for thermally treating the film web 11, the film web 11 being meanderingly transported through the film installation 1 in the machine direction 26 by the roll apparatus 18 processing film material melt 7, here in particular in the form of the casting roll 4.

In the embodiment shown in the single FIGURE, the first temperature-control apparatus 22 is a pre-temperature-control apparatus 28, which is connected directly downstream of the casting roll 4 and thus of the roll apparatus 18 which processes the film material melt 7 in the machine direction 26. The pre-temperature-control apparatus 28 has two corresponding pre-temperature control rolls 29 and 30, both of which are chromium-plated steel rolls with a diameter of 310 mm. The two pre-temperature control rolls 29 and 30 can be tempered in such a way that temperatures of 90° C. to 110° C. can be set on their respective roll surfaces (no longer explicitly quantified). The two pre-temperature control rolls 29 and 30 are also characterized by a wrap angle of at least 160°. Furthermore, they can be driven individually, whereby a lead can be set on the pre-temperature control apparatus 28.

The first temperature control apparatus 22 or the pre-temperature control apparatus 28 is essentially used for uniform temperature control of the film web 11 to stretching temperature, the stretching temperature preferably being above the respective recrystallization temperature of the film material melt 7.

In this embodiment, the second temperature control apparatus 23 is designed as a temperature control apparatus 32, which comprises two temperature-controlled rolls 33 and 34, the temperature-controlled rolls 33 and 34 each being designed as a chromium-plated steel roll with a diameter of 310 mm. The temperature-controlled rolls 33 and 34 are arranged relative to one another in such a way that they each provide a wrap angle of 220° for the film web 11. A lead can also be set on the temperature-controlled apparatus 32.

By means of the temperature-controlled apparatus 32, the film web 11 or the film material is briefly tempered below the melting temperature of the film material in order to remove residual stresses in the film 2 or the film web 11 by introducing tensile stress into the film web 11.

For this purpose, the first temperature-controlled roll 33 and the second temperature-controlled roll 34 can be heated in such a way that they can be operated with surface temperatures of approximately 100° C. to 110° C.

The temperature-controlled rolls 33 and 34 are often also referred to as annealing rolls.

Furthermore, the film installation 1 according to the embodiment shown comprises, with respect to the third temperature-controlled apparatus 24, a cooling device 36 which, viewed in the machine direction 26, is connected immediately downstream of the temperature-controlled apparatus 32, wherein by means of the cooling device 36 the film web 11 is cooled down to almost ambient temperature only at this point in time, as a result of which the orientation of the film material molecules is ultimately “frozen” only at the cooling device.

For this purpose, the cooling device 36 in this embodiment comprises two cooling rolls 37 and 38, which in turn are designed as chromium-plated steel rolls, each with a diameter of 310 mm.

The temperature of the two cooling rolls 37 and 38 can be adjusted in such a way that a maximum surface temperature of 100° C. can be provided at their respective roll surfaces.

The cooling rolls 37 and 38 are arranged opposite one another in such a way that they each ensure a wrap angle of at least 220° for the film web 11.

In addition, the stretching apparatus 20 has two stretching roll groups 40 and 41, at least in this embodiment. Each of the stretching roll groups 40 or 41 consists of a first pair of stretching roll contact rolls 42 or 43 and an auxiliary roll 44 or 45.

The first pair of stretching rolls and contact rolls 42 has a rubberized stretching roll 46 and a corresponding contact roll 47.

Accordingly, the second pair of stretching rolls and contact rolls 43 also has a rubberized stretching roll 48 and a contact roll 49 corresponding thereto.

While the first and second stretching rolls 46 and 48 each comprise a rubberized steel roll with a diameter of 210 mm, the first and second contact rolls 47 and 49 each comprise a chromium-plated steel roll with a diameter of 210 mm.

At least one of the two stretching rolls 46 or 48 can be tempered, preferably in such a way that a surface temperature of around 120° C. can then be set on the respective stretching roll 46 or 48.

Furthermore, the individual roll-contact roll pairs 42 and 43 are driven individually, so that a stretching factor or a lead is preferably continuously adjustable at the stretching apparatus 20.

Racking or stretching of film 2 or of film web 11 at a ratio of 1:4 can be achieved by means of stretching apparatus 20.

Furthermore, the stretching apparatus 20 has a stretching gap length 50, which is preferably adjustable.

It is advantageous if the stretching gap length 50 is as small as possible so that the stretching apparatus 20 is as compact as possible and, in particular, the risk is reduced that film web 11 cools down unfavorably inside the stretching apparatus 20 or between the two pairs of stretching roll contact rolls 42 and 43 of the stretching apparatus 20.

The two auxiliary rolls 44 and 45 have a substantially smaller diameter than the stretching rolls 46 and 48, respectively, and the contact rolls 47 and 49, respectively, but are also each formed by a chromium-plated steel roll.

Advantageously, in the embodiment shown in the single FIGURE, the film installation 1 is set up in such a way that the stretching apparatus 20 is arranged downstream of the at least one film-producing roll 19 or the casting roll 4 in the machine direction 26, circumventing a critical cooling section 53.

According to the representation according to the single FIGURE, the critical cooling section 53 is shown and drawn only symbolically in order to illustrate its position schematically within the present film installation 1.

In this embodiment, it corresponds to a transfer section 54 in which the film web 11 is guided between the casting roll 4 and an input roll 58 of the stretching apparatus 20.

In a very simple case (not shown here), the input roll 58 may at the same time embody a film web removal roll 60, by means of which the film web 11 can be removed from the casting roll 4.

In other words, this means that the stretching apparatus 20 is arranged opposite the roll apparatus 18 processing film material melt 7 or its film-producing roll 19 or, in particular, the present casting roll 4 in such a way that the risk of unintentional critical cooling of the film web 11 on the transfer section 54 can ideally be excluded after the film web 11 leaves the roll apparatus 18 processing film material melt 7 and reaches the stretching apparatus 20 or the input roll 58 of the stretching apparatus 20.

For the purposes of the present invention, the term “critical cooling section” describes a section (transfer section 54) running essentially in the machine direction 26, which the film web 11 covers from the film-producing roll 19 to the input roll 58 of the stretching apparatus 20, whereby this section can run in a straight line or, as shown in this embodiment according to the single FIGURE, can have a number of curves.

In the sense of the invention, the term “critical cooling section” further describes a section in which the film web 11 can cool to below a stretching temperature of the respective film web material or of the respective film web 11 up to now in the prior art, the respective stretching temperature also being dependent on the respective film material used.

The critical cooling section 53 or the transfer section 54 begins with the detachment of the film web 11 from the film-producing roll 19 or the casting roll 4 of the roll apparatus 18 which processes the film material melt 7.

The critical cooling section 53 or the transfer section 54 therefore ends with the contact of the film web 11 with the stretching apparatus 20 or, in particular, with the input roll 58 of the stretching apparatus 20.

According to a very simple embodiment of the present invention or of the film installation 1, a critical cooling section 53 in the sense of the present invention can be avoided, if the input roll of the stretching apparatus immediately represents a film web removal roll 60, by means of which the film web 11 can be directly removed from the film-producing roll 19. However, this is not the case in the embodiment of the film installation 1 shown in the single FIGURE, since the pre-temperature control apparatus 28 is still placed between the stretching apparatus 20 and the roll apparatus 18 which processes the film material melt 7. If such a pre-temperature control apparatus 28 was dispensed with in an alternatively designed film installation 1, the input roll 58 of the stretching apparatus 20 already described above would take over the film web removal roll 60.

However, in order to avoid the risk of an embodiment of a critical cooling section 53 on the film installation 1 in the sense of the invention, the stretching apparatus 20 is arranged opposite the roll apparatus 18 processing film material melt 7 in such a way that the distance 62, in particular between the film-producing roll 19 or casting roll 4 and the input roll 58 (film web removal roll 60) of the stretching apparatus 20, is less than 1000 mm or less than 800 mm, preferably less than 500 mm or 100 mm.

In order for the pre-temperature control apparatus 28 to still find space between the casting roll 4 and the input roll 58, the distance 62 in the embodiment according to the single FIGURE is less than 1000 mm but more than 800 mm.

According to the embodiment shown in the single FIGURE, critical cooling of the film web 11 during transfer from the roll apparatus 18 processing the material melt 7 to the stretching apparatus 20 is prevented by the pre-temperature control apparatus 28 arranged in between them.

In other words, this means that a critical cooling path 53 in the sense of the invention exists neither between the pre-temperature control apparatus 28 and the roll apparatus 18 processing the film material melt 7 nor between the pre-temperature control apparatus 28 and the stretching apparatus 20.

In this respect, the film system 1 according to the embodiment of the single FIGURE is set up in such a way that the stretching apparatus 20 is arranged downstream of the film-producing roll 19 or casting roll 4 in the machine direction 26 in such a way that the film web 11 leaving the film-producing roll 19 or casting roll 4 is transferred to the pre-temperature control apparatus 28 and then to the stretching apparatus 20.

The advantage of the stretching apparatus 20 being arranged downstream of the at least one film-producing roll 19, circumventing a critical cooling section 53 in the machine direction 26, is to be seen in the fact that the film web 11 is stretched exclusively with the aid of the heat from the film material melt 7.

In this respect, the stretching temperature required for a stretching process which can be carried out at the stretching apparatus 20 is generated here entirely or at least up to 80% by means of the roll apparatus 18 processing a film material melt 7.

In other words, this means that, in the sense of the invention, stretching is carried out exclusively with the aid of the heat inherent in the film material or film web 11.

This advantageously avoids cooling of the film material of the film web 11 below a still reasonable stretching temperature.

It is understood that the heat from the roll apparatus 18 processing the film material melt and from the stretching apparatus 20, which may also have an additional thermal effect on the film material or the film web 11, is negligible.

Depending on the film material from which the film 2 or the film web 11 to be produced is to be produced or on the type of film 2 or film web 11 involved, it is advantageous for the film web 11 to be supplied to a pre-temperature control apparatus 28 after leaving the at least one film-producing roll 19 and then transferred from the pre-temperature control apparatus 28 directly to the stretching apparatus 20, as shown according to the single FIGURE.

By means of the pre-temperature control apparatus 28, however, it is very well possible to equalize the temperature or the heat within the film web 11 as much as possible, whereby the racking or stretching quality of the immediately following stretching process can be increased even further.

At this point, it should be explicitly pointed out that features of the solutions described above or in the claims and/or the single FIGURE can also be combined, if necessary, in order to be able to implement or achieve the explained features, effects and advantages correspondingly cumulatively.

It is understood that the embodiment explained above is only a first embodiment of a film installation according to the invention. In this respect, the embodiment of the invention is not limited to this embodiment.

All features disclosed in the application documents are claimed to be essential to the invention, insofar as they are novel, individually or in combination with each other, over to the prior art.

### LIST OF REFERENCE SIGNS USED

1 Film installation
2 Films
3 Cast film installation
4 Casting roll
5 Entry
6 Extruder device
7 Film material melt or plastic melt
8 Wide spray nozzle
9 Film material melt vane
10 Roll surface
11 Film web
15 Direction of rotation
16 Casting roll axis
18 Roll apparatus
19 Film-producing roll
20 Stretching apparatus
22 First temperature control apparatus
23 Second temperature control apparatus
24 Third temperature control apparatus
26 Machine direction
28 Pre-temperature control apparatus
29 First pre-temperature control rolls
30 Second pre-temperature control roll
32 Temperature control apparatus
33 First temperature control roll
34 Second temperature control roll
36 Cooling device
37 First cooling roll
38 Second cooling roll
40 First group of stretching rolls
41 Second group of stretching rolls
42 First pair of stretching roll contact rolls
43 Second pair of stretching roll contact rolls
44 First auxiliary roll
45 Second auxiliary roll
46 First stretching roll
47 First contact rolls
48 Second stretching roll
49 Second contact rolls
50 Stretching gap length
53 Cooling section
54 Transfer section
58 Input roll
60 Film web removal roll
62 Distance

1. Film installation for producing a film web, in particular cast film installation or smoothing calender installation, having a machine direction in which the film web is conveyed through the film installation, having a roll apparatus which processes a film material melt and comprises at least one film-producing roll or a film-producing gap, having temperature control apparatuses for thermally treating the film web and a stretching apparatus for stretching the film web, characterized in that the stretching apparatus is arranged downstream of the at least one film-producing roll, circumventing a critical cooling section in the machine direction.

2. Film installation according to claim 1, characterized in that a distance and/or a transfer distance between the at least one film-generating roll and an input roll of the stretching apparatus is less than 1000 mm or less than 800 mm, preferably 500 mm or less.

3. Film installation according to claim 1, characterized in that a distance and/or a transfer distance between the at least one film-producing roll and an input roll of the stretching apparatus is more than 200 mm or more than 250 mm, preferably more than 450 mm.

4. Film installation according to claim 1, characterized in that the stretching temperature required for a stretching process which can be carried out on the stretching apparatus can be generated in its entirety or at least at 50%, preferably at least to 80% or more, by means of the roll apparatus processing a film material melt.

5. Film installation according to claim 1, characterized in that the stretching apparatus is arranged downstream of the film-generating roll in the machine direction in such a way that the film web leaving the at least one film-generating roll can be transferred directly to the stretching apparatus.

6. Film installation according to claim 5, characterized in that the stretching apparatus comprises a film web removal roll by means of which the film web can be removed directly from the film-producing roll.

7. Film installation according to claim 1, characterized in that the stretching apparatus is arranged downstream of the film-generating roll in the machine direction in such a way that the film web leaving the film-generating roll can be transferred first to a pre-temperature control apparatus and then to the stretching apparatus.

8. Film installation according to claim 1, characterized in that the stretching apparatus comprises at least one temperature-controllable stretching roll.

9. Film installation according to claim 8, characterized in that the pre-temperature control apparatus comprises at least one film pre-temperature control roll, by means of which the film web can be pre-tempered at a temperature above 70° C., preferably between 90° C. and 120° C.

10. Method for producing, in particular for casting-rolling or smooth-rolling, a film web, in which a film material melt is supplied to a relevant roll apparatus which processes a film material melt having at least one film-producing roll and/or a film-producing gap, and this film material melt is formed into the film web by means of the at least one film-producing roll and/or the film-producing gap, and in which the film web is subsequently supplied to different temperature control apparatuses and to at least one stretching apparatus, in particular for operating a film installation according to claim 1, characterized in that the stretching temperature required for a stretching process which can be carried out at the stretching apparatus is generated in its entirety or at least at 50%, preferably at least at 80% or more, by means of the roll apparatus 4 which processes a film material melt.

11. Method for producing, in particular for casting-rolling or smooth-rolling, a film web, in which a film material melt is supplied to a roll apparatus processing a film material melt in this respect having at least one film-producing roll and/or a film-producing gap, and this film material melt is formed into the film web by means of the at least one film-producing roll and/or the film-producing gap, and in which the film web is subsequently supplied to different temperature control apparatuses and at least one stretching apparatus, in particular for operating a film installation according to claim 1, characterized in that the film web is stretched from the film material melt exclusively with the aid of the heat.

12. Method according to claim 11, characterized in that the film web is stretched in addition to the heat from the film material melt by means of heat from the roll apparatus processing a film material melt and the stretching apparatus.

13. Method for producing, in particular for casting-rolling or smooth-rolling, a film web, in which a film material melt is supplied to a relevant roll apparatus which processes a film material melt having at least one film-producing roll and/or a film-producing gap, and this film material melt is formed into the film web by means of the at least one film-producing roll and/or the film-producing gap, and in which the film web is subsequently supplied to different temperature control apparatuses and at least one stretching apparatus, characterized in that the film web, after leaving the at least one film-generating roll and/or the film-generating gap, is stretched by a stretching apparatus, circumventing further temperature control apparatuses.

14. Method for producing, in particular for casting-rolling or smooth-rolling, a film web, in which a film material melt is supplied to a roll apparatus which processes a film material melt having at least one film-producing roll and/or a film-producing gap, and this film material melt is formed into the film web by means of the at least one film-producing roll and/or the film-producing gap, and in which the film web is subsequently supplied to different temperature control devices and at least one stretching apparatus, characterized in that the film web, after leaving the at least one film-generating roll and/or the film-generating gap, is supplied to a pre-temperature control apparatus and is subsequently transferred from the pre-temperature control apparatus directly to a stretching apparatus, by means of which the film web is stretched.

15. Use of a roll apparatus which processes a film material melt for heating a film web to stretching temperature for a stretching process directly following the roll apparatus which processes the film material melt on a film installation which produces a film web.
